(19) United States
(12) Patent Application Publication
(10) Pub. No.: US 2014/0330566 A1
(43) Pub. Date: Nov. 6, 2014

(54) PROVIDING SOCIAL-GRAPH CONTENT BASED ON A VOICE PRINT

(71) Applicant: LINKEDIN CORPORATION, Mountain View, CA (US)

(72) Inventor: Jonathan Redfern, Mountain View, CA (US)

(73) Assignee: LinkedIn Corporation, Mountain View, CA (US)

(21) Appl. No.: 13/888,049

(22) Filed: May 6, 2013

(51) Int. Cl. G10L 17/00

(52) U.S. Cl. CPC G10L 17/005
USPC 704/246

(57) ABSTRACT

During a communication technique, an individual is identified based on a signal that includes vocal sounds of the individual and a voice print of the individual. For example, the voice print may include features characteristic of the individual's voice. Alternatively or additionally, the identification may be based on context information associated with a conversation that includes the individual and/or based on pronunciation of the individual's name. After the individual is identified, content in a social graph, which is associated with the individual, may be accessed and provided. This content may include business information, such as: contact information, education information, a job title, an organization associated with the individual, and/or connections of the individual to other individuals in the social graph.

### BACKGROUND

1. Field

The described embodiments relate to techniques for content in a social graph. More specifically, the described embodiments relate to techniques for providing content in a social graph related to an individual after the individual has been identified based on their voice print.

2. Related Art

People regularly provide information about themselves to third parties. For example, individuals may exchange business cards or credential information when they first meet. Similarly, an individual may provide a copy of their résumé during an interview so that a counterparty in the discussion knows more about them and their background.

However, the aforementioned communication techniques are limited by the need for the individual(s) to explicitly provide the information (i.e., a direct action is required). Furthermore, the information provided is often constrained by the format of the information (business cards, résumés, etc.) and the requirement that it be provided at certain times during discussions. These constraints often limit the usefulness of the information, which can be frustrating for the participants in the discussions and which can constitute a significant opportunity cost.

### BRIEF DESCRIPTION OF THE FIGURES

FIG. 1 is a flow chart illustrating a method for providing content in a social graph that is associated with an individual in accordance with an embodiment of the present disclosure.

FIG. 2 is a flow chart further illustrating the method of FIG. 1 in accordance with an embodiment of the present disclosure.

FIG. 3 is a drawing illustrating a social graph in accordance with an embodiment of the present disclosure.

FIG. 4 is a block diagram illustrating a system that performs the method of FIGS. 1 and 2 in accordance with an embodiment of the present disclosure.

FIG. 5 is a block diagram illustrating a computer system that performs the method of FIGS. 1 and 2 in accordance with an embodiment of the present disclosure.

FIG. 6 is a block diagram illustrating a data structure for use in the computer system of FIG. 5 in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

Embodiments of a computer system, a technique for providing content in a social graph that is associated with an individual, and a computer-program product (e.g., software) for use with the computer system are described. During this communication technique, an individual is identified based on a signal that includes vocal sounds of the individual and a voice print of the individual. For example, the voice print may include features characteristic of the individual's voice. Alternatively or additionally, the identification may be based on context information associated with a conversation that includes the individual and/or based on pronunciation of the individual's name. After the individual is identified, the content in the social graph, which is associated with the individual, may be accessed and provided. This content may include business information, such as: contact information, education information, a job title, an organization associated with the individual, and/or connections of the individual to other individuals in the social graph.

In this way, the communication technique may dynamically provide the content (e.g., in real time) during a conversation (and, more generally, during interaction) between the individual and one or more other individuals. This approach may significantly improve the usefulness of the provided content. In addition, the communication technique may allow the content to be provided without explicit action by the individual. Consequently, the communication technique may improve the satisfaction of the participants in the discussion(s), may reduce opportunity cost(s) that occur when the content is unavailable in a timely fashion and, thus, may increase the revenue and profitability of a provider of the communication technique.

In the discussion that follows, an individual, a user or a recipient of the content may include a person (for example, an existing customer, a new customer, a student, an employer, a supplier, a service provider, a vendor, a contractor, etc.). More generally, the communication technique may be used by an organization, a business and/or a government agency. Furthermore, a ‘business’ should be understood to include: for-profit corporations, non-profit corporations, groups (or cohorts) of individuals, sole proprietorships, government agencies, partnerships, etc.

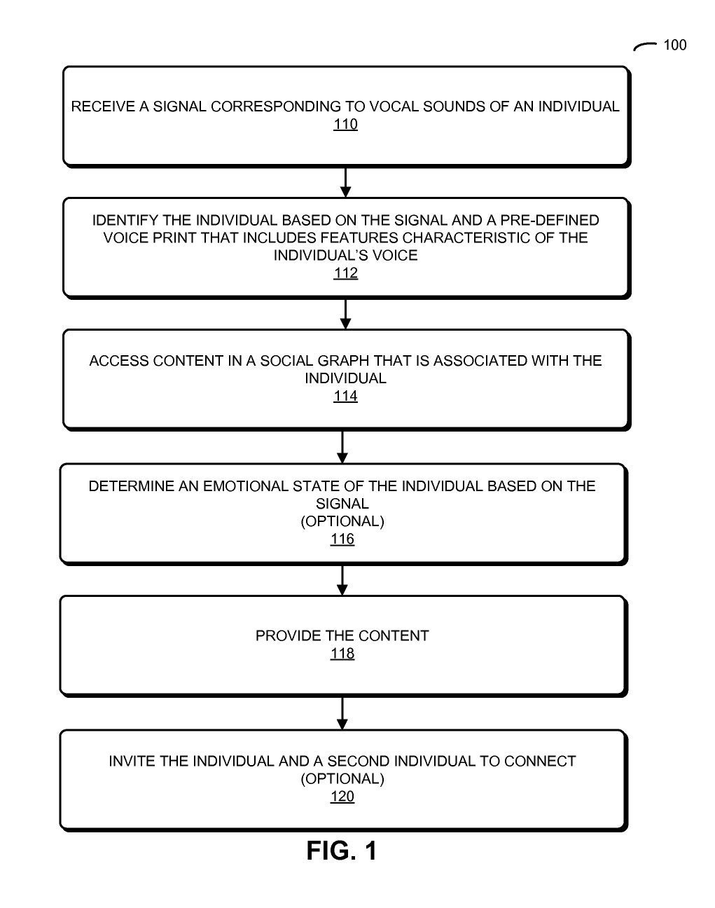

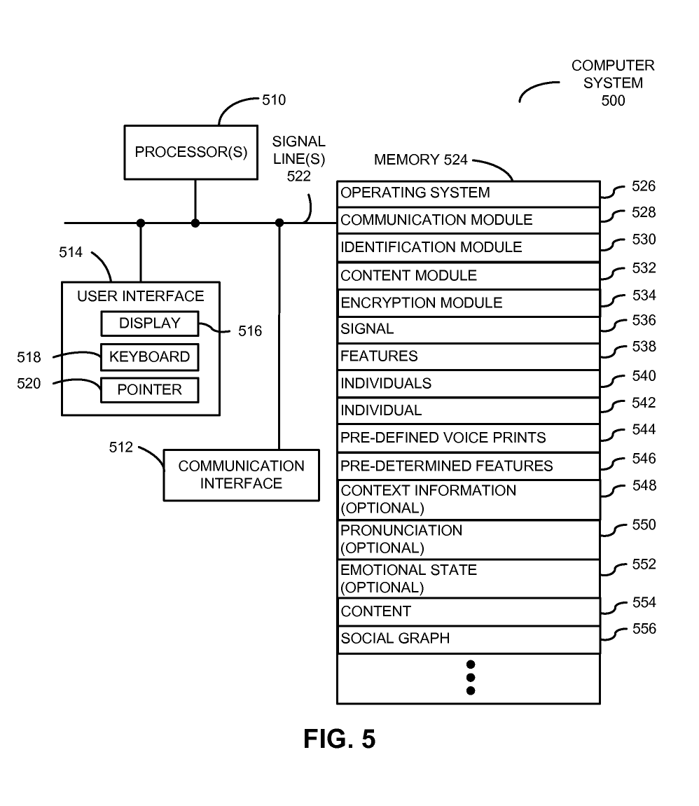

We now describe embodiments of the method. FIG. 1 presents a flow chart illustrating a method 100 for providing content in a social graph that is associated with an individual, which may be performed by a computer system (such as computer system 500 in FIG. 5). During operation, the computer system receives a signal (such as an audio signal or waveform) corresponding to vocal sounds of the individual (operation 110). For example, the vocal sounds may include words spoken by the individual. However, more generally the vocal sounds may include arbitrary sounds generated by the individual's vocal chords (including vocal sounds that are other than those corresponding to spoken words) that facilitate identification of the individual.

Then, the computer system identifies the individual based on the signal and a pre-defined voice print of the individual that includes features characteristic of the individual's voice (operation 112). For example, the computer system may extract features from the signal and may compare these extracted features with a dataset of pre-defined voice prints of different individuals. The pre-defined voice print having features that are the closest match to the extracted features may specify the identified individual. Alternatively or additionally, the identification may involve a match between the extracted features and the features associated with the pre-defined voice print that exceeds a threshold, such as 90%. Note that the features associated with the pre-defined voice print may be derived from a previous signal corresponding to vocal sounds of the individual. In particular, the features may include any combination of temporal or frequency-domain information (e.g., amplitude, spectral content, phase, temporal spacing between sounds), as well as parameters derived from this information (such as parameters that characterize audio content in particular spectral bands, voice stress, etc.).

In some embodiments, the identifying (operation 112) is based on context information associated with a conversation between the individual and a second individual. For example, key word analysis of the conversation may allow a topic or an entity (such as an organization or company) to be identified, which may be used to limit possible candidates during speech or voice identification of the individual. Similarly, lexicography of the conversation may allow a native language of the individual to be identified, which may also be used to limit possible candidates during speech or voice identification of the individual. In some embodiments, the context information includes a location of the individual. For example, based on the location of an electronic device being used by the individual (which may be determined by a cellular-telephone network or a Global Positioning System), if the name ‘John Smith’ is stated during a conversation, this name may be used in conjunction with the location when accessing the content in the social graph (see below) to determine which John Smith is being discussed. Alternatively or additionally, the pre-defined voice print may include information specifying pronunciation of the individual's name, and the identifying may be based on the pronunciation.

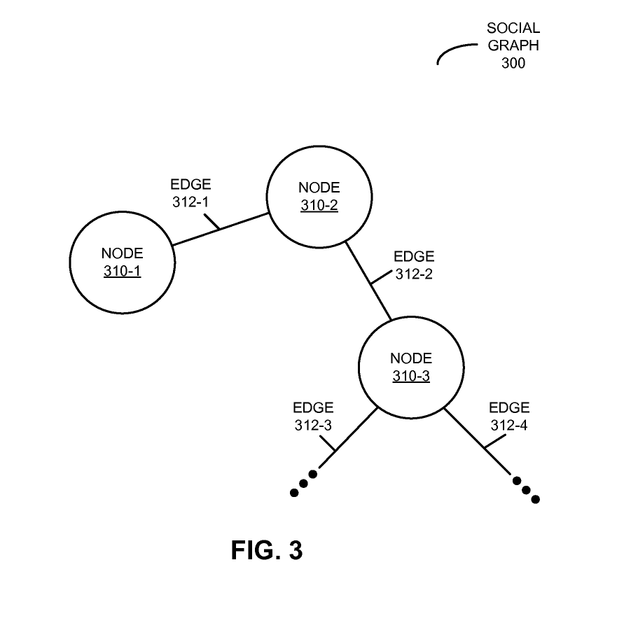

Moreover, the computer system accesses the content in the social graph that is associated with the individual (operation 114). For example, as described further below with reference to FIG. 3, the social graph may include profiles of individuals, with nodes corresponding to entities (such as the individuals, attributes associated with the individuals and/or organizations associated with the individuals) and edges corresponding to connections between the entities (and, thus, the nodes). In general, ‘entity’ should be understood to be a general term that encompasses: an individual, an attribute associated with one or more individuals (such as a type of skill), a company where the individual worked or an organization that includes (or included) the individual (e.g., a company, an educational institution, the government, the military), a school that the individual attended, a job title, etc. Collectively, the information in the social graph may specify profiles (such as business or personal profiles) of individuals.

The computer system may optionally determine an emotional state of the individual (such as angry or frustrated) and/or a situational state of the individual based on the signal (operation 116). For example, the emotional state may be determined based on intonations, temporal spacing between words, voice stress in the vocal signal, etc. Similarly, the situation state may include: the local weather conditions (which may be determined based on the location of the individual, such as the location of an electronic device they are using) or a time of day. Then, the individual's calendar could be accessed to determine if they have back-to-back meetings (i.e., it is a hectic day) or the number of emails or incoming phone calls on their phone to determine how busy they are (i.e., is it a good day or not).

Next, the computer system provides the content (operation 118). For example, the content may include business information associated with the individual, such as: contact information, education information, a job title, an organization or company associated with the individual, skills of or attributes associated with the individual, and/or connections of the individual to other individuals or entities in the social graph (such as connections that the individual and the second individual both have). For example, the connections may include information about the so-called connection strength(s) between the individual and the other individual(s) or entities in the social graph, which may indicate how likely it is that the individual and the other individual(s) or entities have things in common (such as education or work experiences). Alternatively or additionally, based on calendar information of the individual and/or the second individual in the conversation, the content may identify the last time there was a discussion or may include a list of attendees. Note that the content may be provided without direct action by the individual.

Providing the content (operation 118) may be based on the emotional state and/or the situational state determined in operation 116. In particular, if the individual is angry or frustrated, content may be provided to them (for example, based on the context in the discussion or conversation) to assist them (and, thus, to help reduce their frustration). Alternatively, the content may provide a metric of the individual's mood or how their day is going. Thus, the emotional state and the situational state may be used to generate the metric, such as a graphical symbol (e.g., a storm cloud for a ‘bad’ day).

In some embodiments, the computer system optionally invites the individual and the second individual to connect in the social graph (operation 120). For example, if the social graph does not currently include a connection between the individual and the second individual, an invitation may be provided without direct action by the individual or the second individual. However, in some embodiments the optional invitation may be in response to a spoken voice prompt by either the individual or the second individual during the conversation.

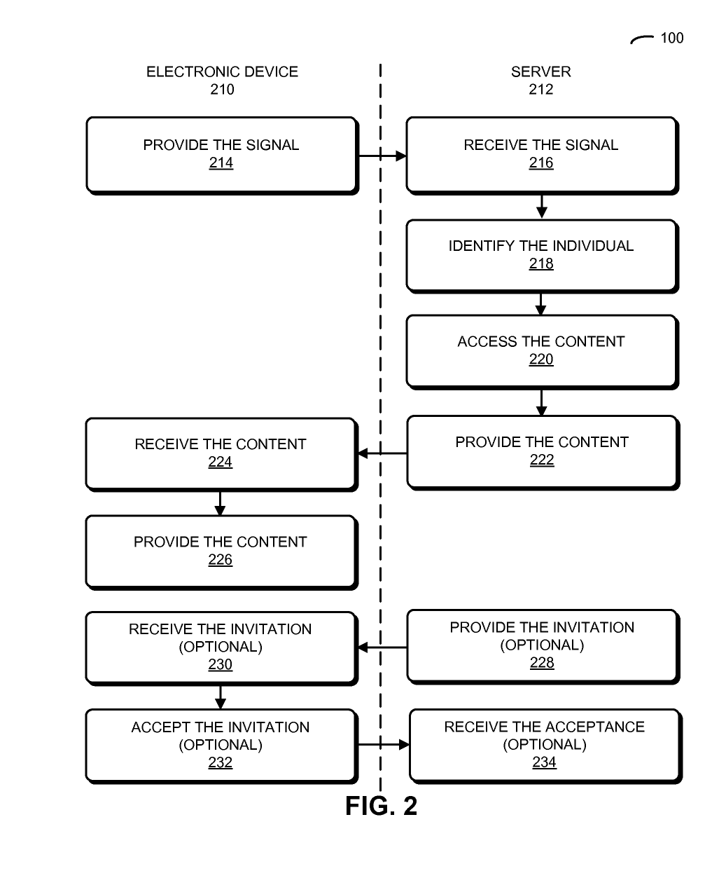

In an exemplary embodiment, the communication technique is implemented using an electronic device (such as a computer, a cellular telephone and/or a portable electronic device) and at least one server, which communicate through a network, such as a cellular-telephone network and/or the Internet (e.g., using a client-server architecture). This is illustrated in FIG. 2, which presents a flow chart illustrating method 100 (FIG. 1). During this method, a user of electronic device 210 (such as the individual) may speak during a telephone call or a conference call. (However, in some embodiments the communication technique is used during a face-to-face meeting.) Moreover, during this conversation, electronic device 210 provides (operation 214) and server 212 receives (operation 216) the signal (such as the audio signal). In response, server 212 identifies the individual (operation 218) based on the signal and the pre-defined voice print of the individual (for example, by comparing features extracted from the signal to features associated with the pre-defined voice print). As noted previously, the identification may also be based on context information, pronunciation and/or a determined emotional state of a user of electronic device 210.

Then, server 212 accesses the content (operation 220) in the social graph. Next, server 212 provides (operation 222) and electronic device 210 receives (operation 224) the content. After receiving the content, electronic device 210 may optionally display or provide (operation 226) the content to the user of electronic device 210.

In some embodiments, server 212 optionally provides an invitation (operation 228) and electronic device 210 optionally receives the invitation (operation 230) to connect the user and another individual in the conversation in the social graph. As noted previously, this invitation may be in response to a spoken voice prompt (for example, by the user or the other individual) or may be implicit (i.e., without an explicit action by the user or the other individual). For example, server 212 may use the social graph to determine that the user and the other individual are not connected, and then may provide the invitation (operation 228). Subsequently, the user may optionally accept the invitation (operation 232), and this acceptance may be optionally received (operation 234) by server 212. For example, the user may click on a link in the invitation.

In some embodiments of method 100 (FIGS. 1 and 2), there may be additional or fewer operations. For example, the context information that can be used in the identification (operation 112) may be extended beyond the current conversation. In particular, the context information may include a summary of the history, such as: how often the individual and the second individual speak or meet, the date of their last conversation or meeting, the number of times the individual and the second individual spoke or met, the last N emails they exchanged, common interests, comments or shares that the individual made on the social graph, news articles associated with the individual (such as news articles in when the individual's name appears), etc. Moreover, the order of the operations may be changed, and/or two or more operations may be combined into a single operation.

In an exemplary embodiment, the communication technique is used to facilitate the timely use of information in a social graph. In particular, by identifying one or more individuals in a conversation based on their voice prints, the communication technique can then dynamically provide relevant content (such as profile information) about the one or more individuals in the social graph during the conversation. The content may be provided seamlessly and without direct user action (such as without a user requesting the information) during the conversation (other than having the individuals talk with each other).

For example, after an individual has been identified, their counterparts in the conversation may be provided with their job title or position within an organization. This may allow the counterparts to determine the individual's influence or how much deference to accord them. More generally, contact information may be provided to the counterparts and/or invitations to connect with each (in the social graph) may be provided to all the participants in the conversation.

We now further describe the social graph. As noted previously, the profiles of the individuals, their attributes, associated organizations (or entities) and/or the interrelationships (or connections) may specify a social graph. FIG. 3 is a drawing illustrating a social graph 300. This social graph may represent the connections or interrelationships among nodes 310 (corresponding to individuals, attributes of the individuals, entities, etc.) using edges 312. In the context of the communication technique, the content may correspond to one or more of nodes 310, and individual(s) that match or have this content may correspond to some of the other nodes 310 connected to the content by edges 312. Moreover, additional content in the profiles of the individuals or information associated with the individuals may correspond to a remainder of nodes 310, which may be connected to other nodes by edges 312. In this way, social graph 300 may specify the business information, and may indicate interrelationships or connections between the individuals and organizations.

In an exemplary embodiment, nodes 310 are individuals or organizations associated with individuals, and edges 312 represent connections between individuals and/or organizations. Moreover, nodes 310 may be associated with attributes (such as skills) and business information (such as contact information) of the individuals and/or organizations.

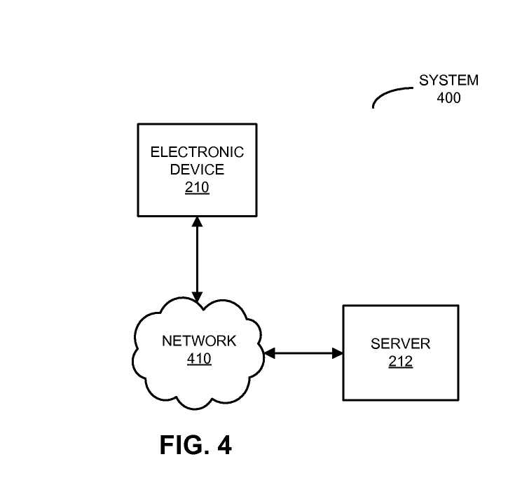

We now describe embodiments of the system and the computer system, and their use. FIG. 4 presents a block diagram illustrating a system 400 that performs method 100 (FIGS. 1 and 2). In this system, a user of electronic device 210 may use a software product, such as a software application that is resident on and that executes on electronic device 210.

Alternatively, the user may interact with a web page that is provided by server 212 via network 410, and which is rendered by a web browser on electronic device 210. For example, at least a portion of the software application may be an application tool that is embedded in the web page, and which executes in a virtual environment of the web browser. Thus, the application tool may be provided to the user via a client-server architecture.

The software application operated by the user may be a standalone application or a portion of another application that is resident on and which executes on electronic device 210 (such as a software application that is provided by server 212 or that is installed and which executes on computer 210).

As discussed previously, the user may use the software application when the user is having a conversation with one or more other individuals (such as a conference call). The software application may capture the signal corresponding to the vocal sounds of the user. This signal may be provided, via network 410, to server 212.

Server 212 may identify the user based on the signal and the pre-defined voice print of the user (for example, the user may have previously enrolled in a service offered by a provider of the communication technique). As noted previously, the identification may also be based on context information, pronunciation and/or a determined emotional state of a user of electronic device 210.

Then, server 212 accesses the content in the social graph. This content may be provided, via network 410, to electronic device 210, which may optionally display or provide the content to the user of electronic device 210.

Note that information in system 400 may be stored at one or more locations in system 400 (i.e., locally or remotely). Moreover, because this data may be sensitive in nature, it may be encrypted. For example, stored data and/or data communicated via network 410 may be encrypted.

FIG. 5 presents a block diagram illustrating a computer system 500 that performs method 100 (FIGS. 1 and 2). Computer system 500 includes one or more processing units or processors 510, a communication interface 512, a user interface 514, and one or more signal lines 522 coupling these components together. Note that the one or more processors 510 may support parallel processing and/or multi-threaded operation, the communication interface 512 may have a persistent communication connection, and the one or more signal lines 522 may constitute a communication bus. Moreover, the user interface 514 may include: a display 516 (such as a touchscreen), a keyboard 518, and/or a pointer 520, such as a mouse.

Memory 524 in computer system 500 may include volatile memory and/or non-volatile memory. More specifically, memory 524 may include: ROM, RAM, EPROM, EEPROM, flash memory, one or more smart cards, one or more magnetic disc storage devices, and/or one or more optical storage devices. Memory 524 may store an operating system 526 that includes procedures (or a set of instructions) for handling various basic system services for performing hardware-dependent tasks. Memory 524 may also store procedures (or a set of instructions) in a communication module 528. These communication procedures may be used for communicating with one or more computers and/or servers, including computers and/or servers that are remotely located with respect to computer system 500.

Memory 524 may also include multiple program modules (or sets of instructions), including: identification module 530 (or a set of instructions), content module 532 (or a set of instructions) and/or encryption module 534 (or a set of instructions). Note that one or more of these program modules (or sets of instructions) may constitute a computer-program mechanism.

During operation of computer system 500, signal 536 may be received using communication interface 512 and communication module 528. Then, identification module 530 may extract features 538 or descriptors determined from or derived from signal 536 that are characteristic of the voice of one of individuals 540.

One of individuals 540, such as individual 542, may be identified based on signal 536 (and, in particular, features 538) and pre-defined voice prints 544 of the one or more individuals 540, which include pre-determined features 546. In particular, features 538 may be compared to pre-determined features 546 to determine match scores, and individual 542 may have a maximum match score or a match score exceeding a threshold value. In addition, individual 542 may be identified using optional context information 548, pronunciation 550 of individual 542 (such as the pronunciation of the individual's name) and/or an emotional state 552 of individual 542 (which may be determined by identification module 530).

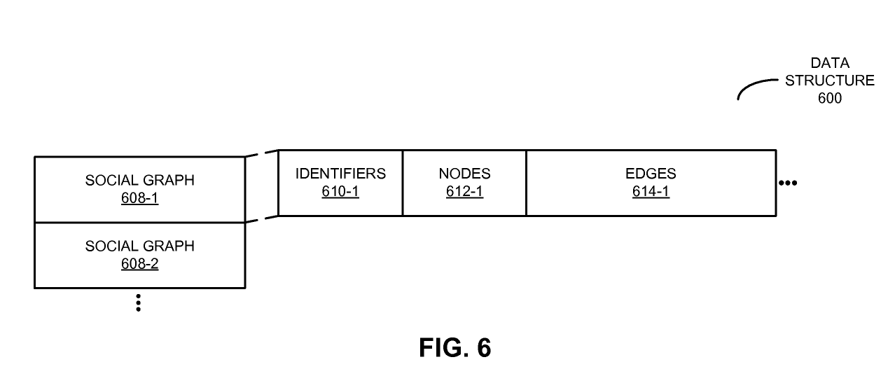

Then, content module 532 may access content 554 in a social graph 556 based on individual 542. Social graph 556 may be included in a data structure. This is shown in FIG. 6, which presents a block diagram illustrating a data structure 600 with one or more social graphs 608 for use in computer system 500 (FIG. 5). In particular, social graph 608-1 may include: identifiers 610-1 for the individuals, nodes 612-1, and/or edges 614-1 that represent relationships or connections between nodes 612-1. For example, nodes 612-1 may include or may be associated with: skills, jobs, companies, schools, locations, etc. of the individuals.

Referring back to FIG. 5, content module 532 may provide content 554 regarding individual 540 using communication module 528 and communication interface 512.

Because information in computer system 500 may be sensitive in nature, in some embodiments at least some of the data stored in memory 524 and/or at least some of the data communicated using communication module 528 is encrypted using encryption module 534.

Instructions in the various modules in memory 524 may be implemented in: a high-level procedural language, an object-oriented programming language, and/or in an assembly or machine language. Note that the programming language may be compiled or interpreted, e.g., configurable or configured, to be executed by the one or more processors.

Although computer system 500 is illustrated as having a number of discrete items, FIG. 5 is intended to be a functional description of the various features that may be present in computer system 500 rather than a structural schematic of the embodiments described herein. In practice, and as recognized by those of ordinary skill in the art, the functions of computer system 500 may be distributed over a large number of servers or computers, with various groups of the servers or computers performing particular subsets of the functions. In some embodiments, some or all of the functionality of computer system 500 is implemented in one or more application-specific integrated circuits (ASICs) and/or one or more digital signal processors (DSPs).

Computer systems (such as computer system 500), as well as electronic devices, computers and servers in system 400 (FIG. 4) may include one of a variety of devices capable of manipulating computer-readable data or communicating such data between two or more computing systems over a network, including: a personal computer, a laptop computer, a tablet computer, a mainframe computer, a portable electronic device (such as a cellular phone or PDA), a server and/or a client computer (in a client-server architecture). Moreover, network 410 (FIG. 4) may include: the Internet, World Wide Web (WWW), an intranet, a cellular-telephone network, LAN, WAN, MAN, or a combination of networks, or other technology enabling communication between computing systems.

System 400 (FIG. 4), computer system 500 and/or data structure 600 (FIG. 6) may include fewer components or additional components. Moreover, two or more components may be combined into a single component, and/or a position of one or more components may be changed. In some embodiments, the functionality of system 400 (FIG. 4) and/or computer system 500 may be implemented more in hardware and less in software, or less in hardware and more in software, as is known in the art.

In the preceding description, we refer to ‘some embodiments.’ Note that ‘some embodiments’ describes a subset of all of the possible embodiments, but does not always specify the same subset of embodiments.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. A computer-system-implemented method for providing content in a social graph that is associated with an individual, the method comprising:
receiving a signal corresponding to vocal sounds of the individual;
identifying the individual based on the signal and a pre-defined voice print of the individual that includes features characteristic of the individual's voice;
using the computer system, accessing the content in the social graph that is associated with the individual; and
providing the content.

2. The method of claim 1, wherein the vocal sounds comprise words spoken by the individual.

3. The method of claim 1, wherein the content includes business information associated with the individual.

4. The method of claim 3, wherein the business information includes contact information.

5. The method of claim 3, wherein the business information includes education information.

6. The method of claim 3, wherein the business information includes a job title.

7. The method of claim 3, wherein the business information includes an organization associated with the individual.

8. The method of claim 3, wherein the business information includes connections of the individual to other individuals in the social graph.

9. The method of claim 1, wherein the identifying is based on context information associated with a conversation between the individual and a second individual.

10. The method of claim 9, wherein the method further involves inviting the individual and the second individual to connect in the social graph.

11. The method of claim 1, wherein the method further involves determining one or more of an emotional state of the individual and a situational state of the individual based on the signal; and
wherein the providing is based on at least one of the determined emotional state and the determined situational state.

12. The method of claim 1, wherein the pre-defined voice print includes information specifying pronunciation of the individual's name; and
wherein the identifying is based on the pronunciation.

13. A computer-program product for use in conjunction with a computer, the computer-program product comprising a non-transitory computer-readable storage medium and a computer-program mechanism embedded therein, to provide content in a social graph that is associated with an individual, the computer-program mechanism including:
instructions for receiving a signal corresponding to vocal sounds of the individual;
instructions for identifying the individual based on the signal and a pre-defined voice print of the individual that includes features characteristic of the individual's voice;
instructions for accessing the content in the social graph that is associated with the individual; and
instructions for providing the content.

14. The computer-program product of claim 13, wherein the content includes business information associated with the individual.

15. The computer-program product of claim 14, wherein the business information includes one of: contact information, education information, a job title, an organization associated with the individual, and connections of the individual to other individuals in the social graph.

16. The computer-program product of claim 13, wherein the identifying is based on context information associated with a conversation between the individual and a second individual.

17. The computer-program product of claim 16, wherein the computer-program mechanism further includes instructions for inviting the individual and the second individual to connect in the social graph.

18. The computer-program product of claim 13, wherein the computer-program mechanism further includes instructions for determining one or more of an emotional state of the individual and a situational state of the individual based on the signal; and
wherein the providing is based on at least one of the determined emotional state and the determined situational state.

19. The computer-program product of claim 13, wherein the pre-defined voice print includes information specifying pronunciation of the individual's name; and
wherein the identifying is based on the pronunciation.

20. A computer, comprising:
a processor;
memory; and
a program module, wherein the program module is stored in the memory and configurable to be executed by the processor to provide content in a social graph that is associated with an individual, the program module including:
instructions for receiving a signal corresponding to vocal sounds of the individual;
instructions for identifying the individual based on the signal and a pre-defined voice print of the individual that includes features characteristic of the individual's voice;
instructions for accessing the content in the social graph that is associated with the individual; and
instructions for providing the content.
